(19) United States
(12) Patent Application Publication
(10) Pub. No.: US 2009/0007479 A1
(43) Pub. Date: Jan. 8, 2009

(54) MANUALLY ACTIVATED ROTATABLE DECOY STAKE

(76) Inventor: Gabriel P. Jerome, SR., Freeville, NY (US)

Correspondence Address: BROWN & MICHAELS, PC;400 M & T BANK BUILDING, 118 NORTH TIOGA ST, ITHACA, NY, 14850, US

(21) Appl. No.: 11/774,192

(22) Filed: Jul. 6, 2007

(51) Int. Cl. A01M 31/06

(52) U.S. Cl. 43/2; 248/156

(57) ABSTRACT

The present invention includes a decoy stake designed to support and impart motion to an animal decoy. The stake is preferably removably attached to a decoy and is controlled directly by a human observer through a simple mechanism such as a string, wire, or filament coupled to a rotatable mechanism contained within the stake. Preferably, the rotation mechanism is biased so that it returns to a determined rotational position when no force is applied by the operator. The invention further provides a method of attracting an animal using a manually rotatable decoy stake. The method includes attaching a decoy to the rotatable stake, placing the stake and attached decoy in a location where it is likely to be observed by the animal, and manually rotating the stake from a concealed location to impart rotational movement to the decoy.

### BACKGROUND OF THE INVENTION

1. Field of the Invention

The invention pertains to the field of hunting decoys. More particularly, the invention pertains to a manually-activated rotatable stake for supporting and rotating a hunting decoy.

2. Description of Related Art

It has long been a common hunting tactic to attract quarry with artificial decoys resembling animals. For the most part, such decoys have been non-moving representations of an animal. Static decoys may be effective under certain circumstances, but their utility tends to be limited since approaching animals often cease to be deceived when they observe the unnatural stillness of such decoys. As such, there is interest in decoys that move in some fashion.

A number of strategies are employed to provide animate decoys. For instance, some are designed to move in response to natural forces such as wind or moving water. However, imperfect conditions and inherent limitations in the design and surrounding environment often cause these decoys to exhibit atypical or unrealistic movements which may startle or warn the target animal or may have no affect at all.

Other animated decoys incorporate mechanical apparatus and/or electric motors within the decoy to simulate animal movements. A major disadvantage of such mechanized decoys is that the means used for imparting movement is a permanent part of the decoy itself and thus adds substantially to the cost of the decoy. Also, it is widely known that these mechanized decoys, especially ones having moving extremities, are complex structures that are delicate and often unreliable. Furthermore, they are often cumbersome to store and transport, and difficult to assemble, operate and maintain. Moreover, they often provide poor simulation of some animal movements, for instance because their range or speed of movement is limited by the motor or mechanism controlling them and thus often fail to mimic realistic animal behaviors. This is particularly true when the mimicked behaviors involve mating, territorialism or other intraspecies communications since animals responsive to these communications typically have a highly evolved ability to discriminate and interpret such movements.

Prior art animated decoys as described above are well represented in the literature.

Samnara, U.S. Pat. No. 6,092,322, discloses the use of a wind activated animal decoy. Specifically, the patent discusses the use of a turkey decoy with tail-feathers, which upon wind activation, causes the head to move up and down and side-to-side.

Brint, U.S. Pat. No. 6,070,356, discloses the use of a full body turkey decoy, having a tail, which uses a battery-powered electric motor and internal counter weights to simulate strutting turkey behavior. Furthermore, Brint shows a turkey decoy that, upon activation, causes the decoy to rotate intermittently on a pivotally attached support rod.

Van Loughman U.S. Pat. No. 6,487,810 discloses a stationary turkey decoy with an auxiliary apparatus for moving a tail component, separate from the body of the decoy. The device is designed to simulate the tail movement of a male turkey, however, it is limited by the fact that while the tail moves, the decoy body remains unnaturally still.

Lenz, U.S. Pat. No. 5,884,427, discloses a battery-operated animal decoy mechanism having a motor. The motor has at least one projecting member which activates a tail flicking attachment, thus simulating the tail flicking of a live animal.

Noles et al. U.S. Patent App. Pub. No. 2005/0204604, discloses a motorized decoy with a moveable head and body designed to simulate the feeding or scavenging motions of a turkey.

None of the above devices provide an inexpensive and simple way to impart lifelike movements representative of mating behaviors or intraspecific communication to an existing static decoy. There remains a need for such a device.

### SUMMARY OF THE INVENTION

The present invention includes a decoy stake designed to support and impart motion to an animal decoy. The stake is preferably removably attached to a decoy and is controlled directly by a human observer through a simple mechanism such as a string, wire, or filament coupled to a rotatable mechanism contained within the stake. Preferably, the rotation mechanism is biased so that it returns to a determined rotational position when no force is applied by the operator.

The present invention further provides a method of attracting an animal using a manually rotatable decoy stake. The method includes attaching a decoy to the rotatable stake, placing the stake and attached decoy in a location where it is likely to be observed by the animal, and manually rotating the stake from a concealed location to impart movement to the decoy.

### BRIEF DESCRIPTION OF THE DRAWINGS

FIG. 1 shows a turkey decoy mounted on a manually rotatable stake of the present invention.

FIG. 2A shows an exploded view of a first embodiment of the invention.

FIG. 2B shows a cutaway view of the assembled stake of FIG. 2A.

FIG. 3A shows an exploded view of a second embodiment of the invention.

FIG. 3B shows a cutaway view of the assembled stake of FIG. 3A.

### DETAILED DESCRIPTION OF THE INVENTION

A manually rotatable decoy stake supports and rotates a decoy. Since a rotatable decoy stake of the present invention is removably attached to the decoy, the same stake may be used to animate different individual decoys. This provides a significant advantage since, for example, the same stake may be used to animate decoys of different species, and may therefore be applicable in different seasons. For example, on one occasion the stake could be attached to a turkey decoy and used attract wild turkey and could, on a different occasion be attached to a deer or goose decoy and used to attract wild deer or geese. Furthermore, because the movement imparting mechanism for the decoy is contained within the stake rather than within the decoy, the high cost of purchasing individual animated decoys is avoided.

An additional advantage of the present invention is that movement of the stake is directly controlled by a human observer. The operator can observe the decoy and activate the stake in a manner that causes the movement of the decoy to mimic a behavior appropriate for the circumstances and even to respond to the behavior of an approaching animal. Furthermore, the operator can exert delicate control over the rate and frequency of movement that is not achievable with electrically operated mechanisms. For example, very small or slow movements can be imparted to convey subtle cues or, alternatively, aggressive and rapid movements can be imparted when a more dramatic behavior would be appropriate from the animal being mimicked by the decoy. Parameters such as the rate and degree of movement are not limited in the present invention by mechanical characteristics such as motor speed. Additionally, direct operation of the decoy can itself provide a measure of entertainment value since the operator is more actively and tactilely involved in the process of attracting the animal than when the decoys are either static, or rely on atmospheric conditions or electrical signals to control their movements.

A further advantage of the present invention is its ability to realistically mimic actual animal behaviors. One example of this advantage is illustrated by its usefulness in turkey hunting. It is well known that male turkeys (toms) are highly territorial, and especially so during their spring mating period. This mating period corresponds with spring turkey hunting season and it is therefore possible to exploit this territoriality in attracting and harvesting male turkeys. In one such method, a decoy of an immature male turkey (known as a jake) is placed in a location where a territorial breeding male is likely to see it. The presence of a jake may elicit an aggressive response from the breeding male and thereby bring him into the firing range of a hunter. This type of territorial confrontation is a ritualized event in which posturing and dominant or submissive behaviors often take the place of actual conflict. In the case of male turkeys, this posturing involves the display of their tail feathers—the shape and size of the tail feathers are indicators of an individual's maturity and dominance—and a male turkey will typically confront another male by directly facing a rival with its tail fan prominently displayed. The specificity and communicativeness of this behavior presents a problem when using a static decoy: when a territorial male turkey issues a challenge, it expects some response. As such, a static decoy will quickly be discovered as fake since it is extremely unnatural for the target of such a challenge to remain motionless. However, if the jake decoy is mounted on a stake of the present invention, a concealed human observer can manipulate the decoy to mimic a behavior appropriate to the situation. If a territorial male turkey appears within visual range, the stake can be rotated by the operator until the jake decoy is directly facing the territorial male. This movement is perceived by the turkey as a challenge and typically elicits an aggressive response which causes it to move toward the location of the decoy. The results are much more effective than can be obtained with a static decoy. Similar strategies are effective for attracting other territorial animals such as other mating fowl, rutting deer, or predators such as coyotes.

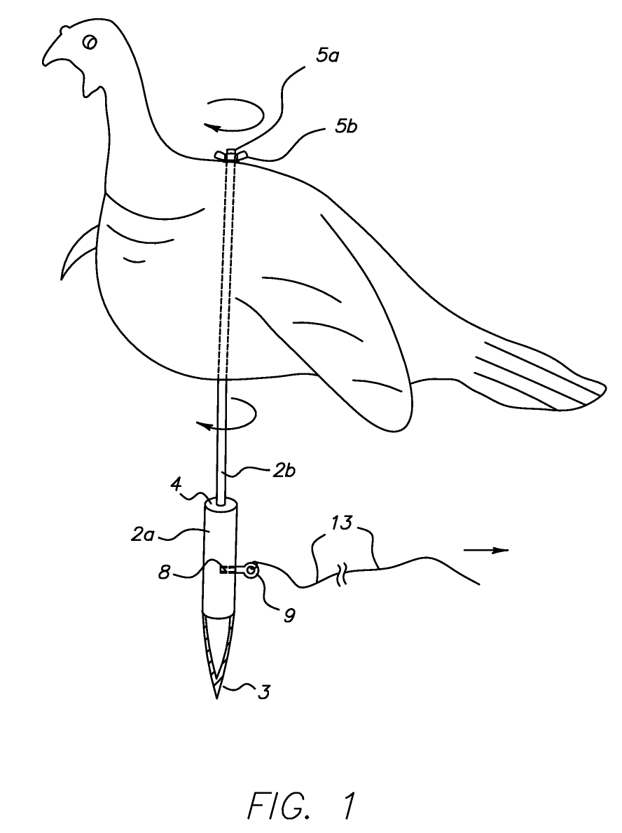

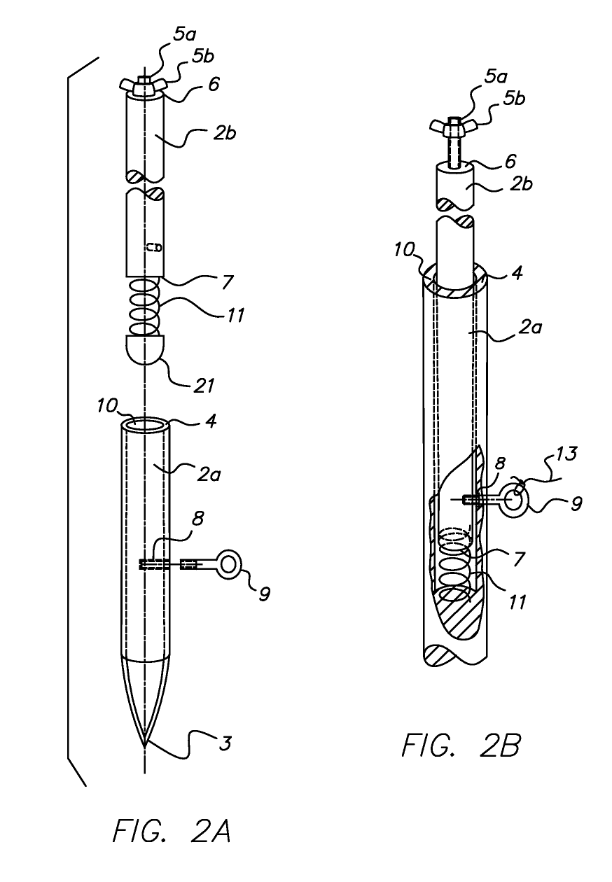

One embodiment of a decoy stake of the present invention is shown in FIGS. 1, 2A, and 2B. In this embodiment, the body of the stake includes two members: a lower member 2a and an upper member 2b. Lower member 2a has a cylindrical longitudinal bore 10 through at least part of its length, a first end 3 adapted for inserting the stake into the ground, and a second end 4, which has an opening to the longitudinal internal bore 10. This opening receives the lower end 7 of upper member 2b. The lower end 7 of the upper member 2b has a substantially cylindrical shape with a diameter chosen to fit freely within the bore 10, thereby allowing a lower portion of the upper member 2b to nest rotatably within lower member 2a. Upper member 2b includes a fastener at its upper end 6 to facilitate attachment of an animal decoy. In the embodiment shown, the fastener includes a threaded stud 5a and a wing nut 5b. The fastener could alternatively, be any other fastener suitable for attachment of a decoy including, but not limited to, a clip, a screw, a pin, a stud, a wire, an adhesive substance, a magnet, a hook and loop fastener, or a suction cup.

In the embodiment of the invention shown in FIGS. 2A and 2B, the lower member 2a has a slot 8 oriented approximately perpendicular to its length. The slot passes through the outer surface of the lower member 2a and intersects the longitudinal internal bore 10. In this embodiment, the slot extends around about half of the wall of the lower member. When the stake is assembled, a connector 9 passes through the slot and is fixedly attached to a portion of upper member 2b contained within the longitudinal bore 10 of lower member 2a. When connector 9 is in place, the upper member cannot be withdrawn from the lower member and is effectively retained in a defined vertical position relative to lower member 2a. The connector 9 includes a point external to the lower member for attachment of a string, line, or filament 13 by which a user may apply a force to the connector. As shown in FIG. 1, when a lateral force is applied to connector 9 by pulling on filament 13, it causes the upper member 2b to rotate around its longitudinal axis. This motion is independent of the lower member 2a since neither connector 9, filament 13, nor upper member 2b are attached to lower member 2a. The length of slot 8 determines the angle through which the upper member can be rotated. When, as in FIGS. 1, 2A and 2B, the slot extends about half way around the lower member, the upper member and any decoy attached thereto will be capable of rotation through about 180 degrees. Obviously, if a longer or shorter slot is provided, the movement is correspondingly expanded or restrained. For instance, a slot extending two thirds of the way around of the exterior of the lower member provides about 240 degrees of rotation while a slot extending about one quarter of the way around of the lower member allows rotation through about 90 degrees. Preferably, the slot is as long as is practical without compromising the structural integrity of lower member 2a.

The filament 13 may be any form of flexible filament including, but not limited to, string, wire, rope, monofilament, thread, or cable. In one embodiment, the filament is an ordinary fishing line which is conveniently stored on and dispensed from a fishing reel.

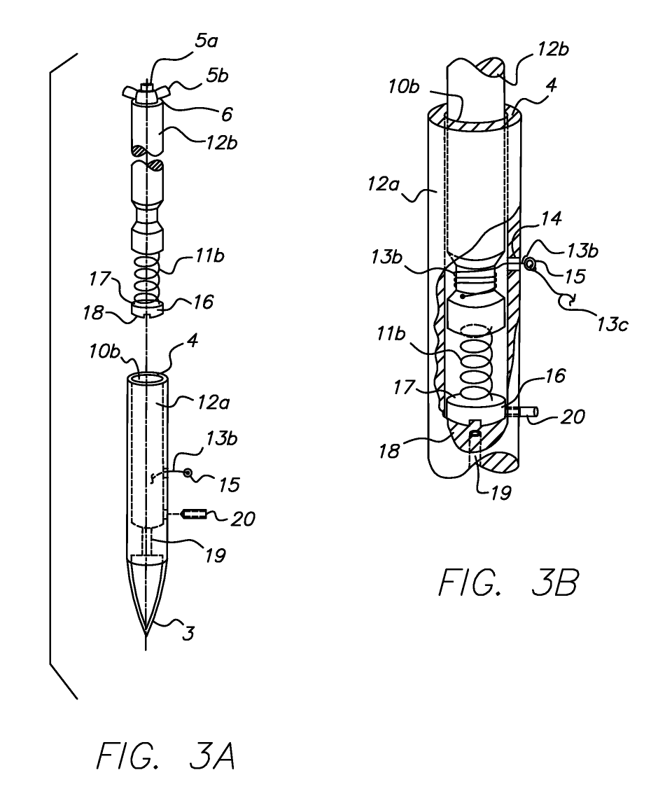

In a preferred embodiment, a biasing element returns the upper member 2b to a defined rotational position when no force is being applied to connector 9. The biasing element may be any mechanism known in the art. In the embodiment shown in FIGS. 2A, 2B, 3A, and 3B, the biasing element is a coil spring 11. Coil spring 11 has a first end fixedly attached to the lower member 2a (or to an intermediate element 21 which is then fixedly attached to lower member 2a) and a second end fixedly attached to the upper member 2b. In this way, when a force applied to connector 9 causes a rotational movement of the upper member 2a relative to lower member 2b, the coil spring is twisted and exerts a counteracting torsional force that biases the two members toward their initial rotational positions. Thus, when the force applied to connector 9 is lessened, the upper member rotates back toward its resting position. If desired, coil spring 11 can be pretensioned to enhance this effect. One method of pretensioning coil spring 11 includes fixing the ends of the spring 11 to the lower and upper members, and then rotating the upper and lower members relative to each other a desired number of turns and keeping the members in this rotated state while the connector 9 is passed through slot 8 and fixedly attached to the upper member 2b. Once connector 9 is attached, the upper and lower members may be released. The torsional force imparted to spring 11 now causes the upper or lower member to rotate in a direction counter to the direction of initial preload rotation, however, they may only rotate through a limited angle before connector 9 contacts an end of slot 8 and prevents further rotation. Once this contact occurs, the remaining torsional force in spring 11 is retained as a pretensioning force.

An alternative embodiment of the invention is depicted in FIGS. 3A and 3B. This embodiment is similar to those described above, but instead of a slot and external connector, a string, wire or filament 13b passes through a hole 14 in the side of lower member 12a to couple the upper member to an operator-applied force. The string, wire, or filament 13b is wrapped around a portion of upper member 12b contained within the longitudinal bore 10b of lower member 12a. As described above, the upper and lower members of the stake are preferably rotationally biased by a spring or other biasing element, and are preferably provided with a preload force to return upper member 12b to a defined rotational position when no external force is being applied. Filament 13b is preferably coupled to an external element 15 sized to prevent its passage through hole 14. In a preferred embodiment, external element 15 is a piece of hardware such as a ring, snap, or swivel adapted for simple coupling of a second filament 13c by which the device may be remotely manipulated by the operator. Alternatively, a single filament may extend from the remote operator through hole 14 and around upper member 12b. In this case, external element 15 is optional, but its presence may be desirable to limit the amount of filament 13b that can be drawn through hole 14.

Since the rotational motion of this embodiment is limited by the number of turns of filament wrapped around the upper member 12b rather than by the length of a slot, it allows a decoy coupled to the stake to be rotated through angles of 360 degrees and greater. This feature may be advantageous in some situations. In the illustrated embodiment, filament 13b passes through hole 14 and is fixedly attached to the lower portion of the upper member 12b. The lower portion of upper member 12b is attached to one end of coil spring 11b. The other end of spring 11b is fixedly attached to plug 16. Plug 16 is contained within the bore 10b in the lower member 12a and has a lower surface 18 accessible from the bottom of lower member 12a, this access may by via a second, smaller longitudinal bore 19 as shown. Preferably, lower surface 18 of plug 16 allows engagement and rotation of the plug, such as a via slot or recess for engagement by a tool inserted from the bottom of the lower member 12a through bore 19. A fixing element 20 is provided to fix plug 16 within the bore 10 so that it cannot rotate. Some examples of suitable fixing elements include, but are not limited to, a fastener such as a set screw or pin that passes through a surface of the lower member and engages the side of the plug, or a more permanent element such as glue or a weld.

A pretensioning force may be applied to the stake of FIG. 3B as follows: upper member 12b is fixedly attached to one end of spring 11b, the other end of spring 11b is fixedly attached to the upper surface 17 of plug 16. This assembly is inserted into the internal bore 10b of lower member 12a to an extent that allows filament 13a to pass through hole 14 and be fixedly attached the desired point of attachment. Once the filament is attached, the upper member assembly is rotated causing filament 13a to wind around upper member 2b until the external element 15 is drawn against the outer surface of the lower member at hole 14. The lower end of plug 16 is then engaged by insertion of an appropriate tool through bore 19 and the plug is further rotated a desired number of turns in the same direction as the upper member assembly was rotated. This further rotation imparts a torsional force to the spring since the end of the spring attached to upper member 12b is prevented from further rotation. Once the desired number of turns have been imparted to the plug, it is fixed in the bore 10b by fastener 20 inserted through the side of lower member 12a. The spring thus retains the torsional force applied to it, and imparts this force to upper member 12b and to filament 13a. Similar biased string-operated mechanisms are known in other devices such as window shades, starter cords for small engines, window sash balances, retractable power cords, etc. and many variations of such mechanisms are well known. Any of these known mechanisms may be adapted to fulfill the above described function.

In the embodiments shown in the figures, the bottom ends of the stakes' lower members have an oblique profile to facilitate their insertion into the ground. Alternatively, one could use a conical end, affix a rigid small diameter rod or wire to the end, or otherwise provide a pointed end suitable for insertion into the ground. Additionally, the bottom may be adapted to include a stand, a weighted member, a floatation device, or other anchoring mechanisms to accommodate various environments where insertion into the ground might be impractical such as in frozen conditions, in deep snow, in swampy areas, or on open water.

The materials from which the stake is constructed may be varied. In one embodiment, the upper and lower members are constructed from a weather resistant plastic. In other embodiments, they may be made from metal, wood, or any other suitable materials. The stake is preferably constructed such that it is relatively inconspicuous when deployed. It is therefore preferred that its surfaces be of a neutral color suitable for blending in with the landscape where it is to be used, or that it be camouflaged. For the same reason, it is desirable that the stake not be overly large or bulky. In particular, the upper member is preferably slender, so that its attachment to a decoy does not detract from the visual illusion created by the decoy. The size of the stake can be altered for application with larger or smaller decoys as required. For example, a decoy of a full grown deer may require a taller, stronger stake, than a decoy for fowl such as ducks, turkeys or geese. In one embodiment, the upper member of the stake may be extendable, or may admit the addition or removal of one or more sections to lengthen or shorten the stake for a particular use. This feature may also be advantageous for moving and storing the stake, since the bulk may be reduced by partial disassembly.

While specific mechanisms are described above to illustrate the invention, the biased rotational motion of the stake may be any number of different mechanisms in addition to those specifically described. In alternative embodiments, the biasing force may be provided by other biasing elements including, but not limited to, torsion springs, flat springs, or spiral springs. Alternatively, an elastic element such as a rubber band may be used. The specifics by which the control filament, and the biasing element are attached to the stake members may be similarly varied.

The present invention also provides a method of attracting animals using the rotatable decoy stakes of the present invention. In one example of the method, a decoy stake of the present invention is used to hunt male turkeys. The upper stake end is fixedly attached to a decoy of a young male turkey. Preferably, the decoy has a tail fan prominently displayed. The stake and the attached decoy (and optionally, other related decoys) are then placed upon or secured to the ground near to a location where a male turkey might pass. One preferred location for the decoy and stake assembly is in an open field near a forest or hedgerow, where a territorial male turkey is expected to forage or pass while patrolling its territory. The decoy is preferably oriented so that it does not, in its resting position, directly face the direction from which an approaching turkey is most expected to first observe the decoy. The user then attaches a control filament or string to external connector 9 or to external element 15 as appropriate and routes the control filament or string to a concealed location where the user will be able to observe the scene and operate the decoy stake. As an example, the control filament may be an ordinary fishing line retained on a fishing reel. In use, the control filament may optionally be routed through secondary guides located between the decoy stake and user both to effectively conceal the filament and to ensure that force applied to the control filament will be conveyed to the stake mechanism along a vector suitable for easily rotating the mechanism within the stake.

When a wild turkey appears and is in visual range of the decoy, the concealed user rotates the stake by applying a force to the control filament so that the decoy directly faces the turkey. A territorial male turkey will typically perceive this movement as a behavior intended to challenge him and his territory and will approach and even attack the decoy, thereby giving a hunter an ample opportunity to fire on the male turkey.

Similar strategies may be used to attract other animals. By considering how the animal represented by a decoy would naturally react to the approach of the animal being attracted, and by mimicking that expected behavior by appropriately rotating the stake, a user may greatly increase the effectiveness of a decoy. Since whether an animal directly faces toward or turns away from an approaching individual is often an important form of animal communication, the appropriate rotation of a decoy on a stake of the present invention can convincingly mimic natural behaviors and thereby greatly increase the decoy's effectiveness relative to a non rotatable decoy.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A manually rotatable decoy stake comprising:
a) a lower stake member comprising:
i) a longitudinal axis;
ii) a first end;
iii) a second end; and
iv) an internal bore parallel to the longitudinal axis;
wherein the first end is adapted for insertion into the ground, and the second end is open to the internal bore;
b) an upper stake member comprising:
i) a longitudinal axis parallel to the longitudinal axis of the lower stake member;
ii) a first end;
iii) a second end; and
iv) an intermediate portion between the first end and the second end;
wherein the first end and at least part of the intermediate portion are located within the internal bore of the lower stake member, and
the second end is coupled to a fastener for attachment to an animal decoy;
c) a biasing element having one end fixedly attached to the upper stake member near its first end and another end fixedly attached to the lower stake member;
d) a connector comprising:
i) a first portion fixedly coupled to a part of the upper stake member contained within the longitudinal bore of the lower stake member;
ii) an intermediate portion extending through a passage in an external wall of the lower member; and
iii) an external portion accessible from outside the lower stake member; and
e) an external filament coupled to the external portion of the connector,
wherein the biasing element causes the upper stake member and the lower stake member to have a defined rotational resting position relative to each other;
wherein a force applied by the external filament to the connector causes the upper stake member to rotate away from the defined rotational resting position; and
wherein when the force applied by the external filament is lessened, the biasing element causes the upper stake member to move back toward its defined rotational resting position

2. The manually rotatable decoy stake of claim 1, wherein the passage in the external wall of the lower stake member comprises a slot communicating with the internal bore and wherein the slot is substantially perpendicular to the longitudinal axes.

3. The manually rotatable decoy stake of claim 2, wherein the slot encompasses a radial angle of about 90 to about 300 degrees relative to the longitudinal axis of the lower stake member.

4. The manually rotatable decoy stake of claim 1, wherein:
a) the connector is selected from the group consisting of: a string, a wire, a cable, a monofilament, a thread, a rope, and a wire;
b) the external portion of the connector comprises an external element coupled to the connector;
c) the connector wraps one or more times around the intermediate portion of the upper stake member located within the longitudinal bore of the lower stake member; and
d) the passage in the external wall of the lower stake member comprises an orifice large enough to allow passage of the connector, but small enough to prevent passage of the entirety of the external element into the internal longitudinal bore.

5. The manually rotatable decoy stake of claim 4 wherein the connector is continuous with the external filament.

6. The manually rotatable decoy stake of claim 4 wherein the connector is removably coupled to the external filament.

7. The manually rotatable decoy stake of claim 1, wherein the upper stake member comprises at least one section that may be added or removed to adjust the length of the upper stake member.

8. The manually rotatable decoy stake of claim 1 wherein the biasing element is selected from the group consisting of:
a) a coil spring;
b) a torsion spring;
c) a flat spring;
d) a spiral spring;
e) an elastic band; and
f) a combination of two or more of a) through e).

9. The manually rotatable decoy stake of claim 1 wherein the rotation away from the resting position is limited to from about 90 degrees to about 300 degrees.

10. The manually rotatable decoy stake of claim 1 wherein the rotation away from the resting position can exceed 360 degrees.

11. A method of attracting an animal using a manually rotatable decoy stake comprising the steps of:
a) fixedly attaching to the rotatable stake a decoy likely to attract the animal;
b) placing the stake in a location where it is likely to be observed by the animal; and
c) manually rotating the decoy stake and the decoy attached thereto from a concealed location by applying a force to a rotation mechanism within the stake.

12. The method of claim 11 wherein the animal is a male turkey and the decoy resembles an immature male turkey.

13. The method of claim 11 wherein the animal is a male deer and the decoy resembles an immature male deer.

14. The method of claim 11 wherein the animal is a predator and the decoy resembles a prey animal.

15. The method of claim 11 further comprising the step between step b) and c) of waiting in a concealed location for an animal to observe the decoy.

16. The method of claim 15 wherein the manual rotation at step c) causes the decoy to directly face the animal the animal observing the decoy.

17. The method of claim 15 further comprising the step after step d) of:
e) further rotating or relaxing the decoy to follow the movements of the animal or to further interest and attract the animal.

18. A manually rotatable decoy stake comprising:
a) a lower stake member having a lower end adapted for ground attachment;
b) an upper stake member having an upper end attachable to a decoy and a lower end rotatably coupled to the lower stake member;
c) a biasing element attached to the lower stake member and to the upper stake member; and
d) a filament coupled to the upper stake member;
wherein the biasing element maintains the upper stake member in a defined rotational position relative to the lower stake member;
wherein manually applying a force to the filament causes the upper stake member to rotate away from the defined rotational position; and
wherein when the force on the filament is lessened the upper stake member rotates back toward the defined rotational position.
